(19) United States
(12) Patent Application Publication
(10) Pub. No.: US 2011/0173616 A1
(43) Pub. Date: Jul. 14, 2011

(54) DETERMINATION AND MANAGEMENT OF VIRTUAL NETWORKS

(75) Inventors: Joël Lattmann, Champs sur Marne (FR); Sarah Nataf, Paris (FR); Fatima Ferrahi, Paris (FR)

(73) Assignee: France Telecom, Paris (FR)

(21) Appl. No.: 13/121,056

(22) PCT Filed: Sep. 15, 2009
(86) PCT No.: PCT/FR2009/051726

§ 371 Date: Mar. 25, 2011

(30) Foreign Application Priority Data
Sep. 29, 2008 (FR) 08/56527

(51) Int. Cl. G06F 9/455

(52) U.S. Cl. 718/1

(57) ABSTRACT

A method for determination of topology of virtual networks comprises the following steps implemented by a physical node, physical nodes being connected by a physical network and designed to support virtual nodes of these virtual networks: determination of resource parameters defining a physical configuration of the physical network and a physical configuration specific to the physical node and determination of request parameters defining service requests relating to the virtual networks. The method further comprises, in the case of modification of at least one parameter belonging to the group comprising the resource parameters and the request parameters between a current point in time and a preceding point in time, the broadcast of at least the modified parameters within the physical network, the updating of the resource and request parameters as a function of the modified parameters and the determination of topologies for the virtual networks by means of the updated parameters.

The present invention relates to the determination and the management of virtual networks on physical networks.

There currently exist techniques that allow “virtual computing machines” to be created. This consists in simulating, by means of software applications, the operation of a machine in a real machine. When the machine is emulated, just as in a real machine, it is possible to execute an operating system such as the systems known by the commercial names Windows, Linux, or Solaris. Once the system has been launched, the virtual machine behaves like a separate machine and allows the software applications supported by the system to be executed.

The main advantage of these virtualization techniques consists in placing side-by-side several virtual machines and systems on the same physical machine in such a manner as to facilitate the transfer of data, to share the resources, to facilitate the saving of data, to simplify the administration and other uses.

The virtual machines see the host machine as an independent machine and are controlled by a virtualization manager from the host machine (Xen, Vmware, UML, etc.).

There exist various virtualization modes adapted to the various user applications, for example operational applications: models, simulation, operational processes (servers, routers, etc.).

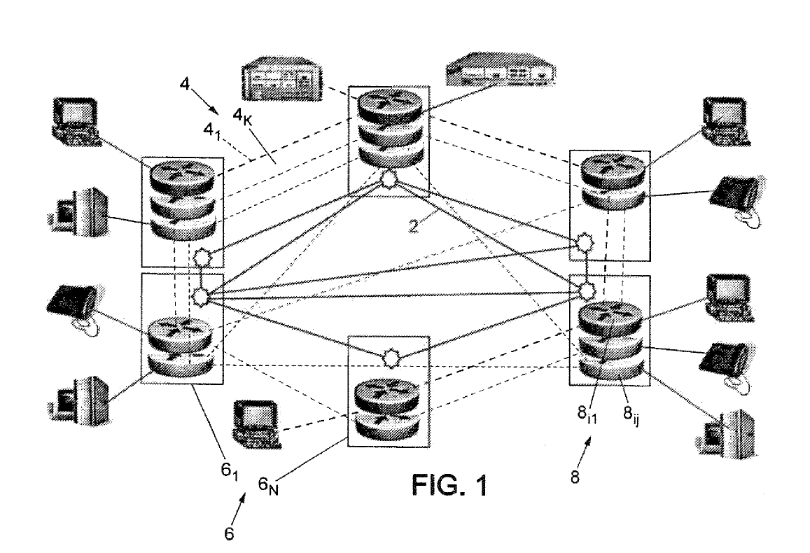

Following the same logic, it appears to be possible to virtualize the networks. Thus, the same physical network, such as the network referenced 2 in FIG. 1, can be used to support several virtual networks 4₁, . . . 4_{K}.

These virtual networks 4 provide the interconnection between sites which either provide services, or are users of these services. The sites are connected via service access points or client access points onto nodes of the physical network. The sites may themselves be sub-components of a telecommunications network which encompasses the physical support nodes of virtual routers.

A virtual network architecture comprises a superposition of different logical topologies established between virtual routers, these virtual topologies being supported by the architecture of the physical network 2. Each of the virtual networks, depending on the services that it has to support, will need to meet particular criteria as regards quality of service, transit time, availability, etc. Such a structure allows a separate service to be assigned to each of the superposed networks.

By virtualizing the networks, it becomes possible to provide a centralized administration for all the virtual networks from a physical support platform, to share resources in order to save space and to reduce power consumption (machines, racks, air conditioning, etc.), to enable upgrading of the virtual networks by installing new versions of operating systems without interfering with the operation of the router.

In addition, the separation of the virtual machines facilitates the differentiation of the various services supported by a physical machine (QOS, Bandwidth reservation, security, etc.).

However, in such a topology, the mechanisms for management of the nodes of the physical network must allow conciliation of the connectivity between connection points of the virtual networks, a certain robustness of the virtual topology (resilience in cases of faults in nodes or physical links) together with the optimization of the sharing of resources of the physical network.

The management and the administration of these virtual networks are therefore particularly complex with respect to conventional physical networks, notably in the case of a fault. Systematic manual management would be particularly limiting and costly and would require human interventions on a high number of nodes of the physical network in order to enable the coherence of the virtual networks to be recovered.

In certain environments, a centralized management of the virtual networks is used. This poses problems of security and leads to the simultaneous generation of commands for modifications to be applied to several physical nodes in the case of upgrade of the network.

It is also possible to use a decentralized or distributed management in physical networks, in which each physical node of the network is capable of taking an autonomous decision relating to the implementation of an operation relating to it.

However, no solution currently exists that allows each node to manage virtual networks in an autonomous and decentralized manner.

The present invention aims to improve this situation by providing a method of determining the topology of virtual networks together with a corresponding program, device and network.

Thus, in one embodiment, the invention relates to a method for determination of topologies of virtual networks, physical nodes being connected by a physical network and being designed to support virtual nodes of said virtual networks. The method comprises the following steps implemented by one of the physical nodes: determination of resource parameters defining a physical configuration of the network and a physical configuration specific to the physical node and determination of request parameters defining service requests relating to the virtual networks and, in the case of modifications of at least one parameter belonging to the group comprising the resource parameters and the request parameters between a current point in time and a preceding point in time, broadcast of at least the modified parameters in the physical network, updating of the resource and request parameters as a function of the modified parameters and determination of topologies for the virtual networks by means of the updated parameters.

Thus, by the broadcast of the modified parameters, each node of the physical network has the same parameters and performs the same calculations for determining the topologies of virtual networks. Accordingly, the method can be automated and implemented by each node of the physical network in an autonomous manner. This allows the situation to be improved by enabling decentralized and autonomous management of the virtual networks supported by the same physical network.

In one particular embodiment, said determination of resource parameters comprises at least one step selected from within the group comprising taking into account predetermined configuration information, reception of information coming from other nodes of the physical network and acquisition of local and remote resources.

In another particular embodiment, said determination of request parameters comprises at least one step selected from within the group comprising taking into account predetermined configuration information, reception of information coming from other physical nodes and taking into account constraints on quality of service.

Thus, the nodes can determine the resources and the requests based on predetermined parameters or on parameters transmitted by other nodes or else acquired by interrogation. A node thus obtains the modified parameters by the other nodes and the determination of the topologies is coordinated between the various nodes of the physical network.

In one particular embodiment, said step for determination of topologies for the virtual networks comprises, for each virtual network, verification of the availability of the resources.

Thus, the method for determination of the topology of the virtual networks verifies that the requests for services and fixed resource parameters, notably for the maintenance of the quality of service, are met.

Advantageously, said step for determination of topologies for the virtual networks comprises, for each virtual network, determination of metrics for each virtual link between the nodes of the virtual network, determination of the shortest pathways between the nodes of the virtual network, union of the shortest pathways in order to create a topology of the virtual network, and determination of the loads for the links between the nodes of the virtual network.

This particular embodiment constitutes a technical alternative for the determination of the topologies.

In one variant, the method furthermore comprises, depending on the determined topologies of the virtual networks, the creation of at least one virtual router on at least one physical node. The method thus comprises an active phase of automatic adaptation of the physical network to the determined topology of the virtual networks.

Advantageously, said steps of updating the parameters and of determination of the topologies are repeated at each modification of the request or resources parameters. Thus, the method allows the automatic adaptation of the virtual networks as soon as a modification is detected.

Advantageously, the method furthermore comprises the management of the virtual networks after the determination of the topology.

In one particular embodiment, the management of the virtual networks comprises, in the case of a fault in a node of the physical network, the broadcast of information within the physical network, convergence of the graph of the physical network and of the topologies of the virtual networks affected by the fault, updating of the resource and request parameters while conserving the parameters defining the links not affected by the fault and an iteration of the method for determination of the topologies.

In another particular embodiment, the management of the virtual networks comprises, in the case of a power-down of a physical router, the broadcast of information within the physical network, the convergence of the graph of the physical network and of the topologies of the virtual networks affected by the fault, the updating of the resource and request parameters and, after the power-down of the physical router, the iteration of the method for the determination of the topologies of the virtual networks.

In yet another variant, the management of the virtual networks comprises, in the case of addition of one or of several access points to a virtual network, the updating of the request parameters and the iteration of the method for the determination of the topologies of the virtual networks.

The invention also relates to a computer program comprising code instructions for the implementation of a method such as previously defined when said program is executed by a computer processor.

The invention furthermore relates to a node of the physical network belonging to a physical network and being designed to support virtual nodes of virtual networks comprising a unit for determination of resource parameters defining a physical configuration of the physical network and a physical configuration specific to the physical node, a unit for determination of request parameters defining service requests relating to the virtual networks, a comparator between the request and resource parameters at a current point in time and the parameters at a preceding point in time, means for broadcasting resource and request parameters within the physical network, means for updating the resource and request parameters as a function of the modified parameters and a processor designed for the determination of topologies for the virtual networks by means of the updated parameters.

The invention also relates to a physical telecommunications network comprising a plurality of physical nodes connected together and designed to support virtual nodes of virtual networks, characterized in that at least two of said physical nodes are nodes such as previously mentioned.

Other features and advantages of the present invention will become apparent in the non-limiting description presented hereinafter, and with reference to the appended drawings in which:

FIG. 1, which has already been mentioned, describes the architecture of a physical network supporting several virtual networks;

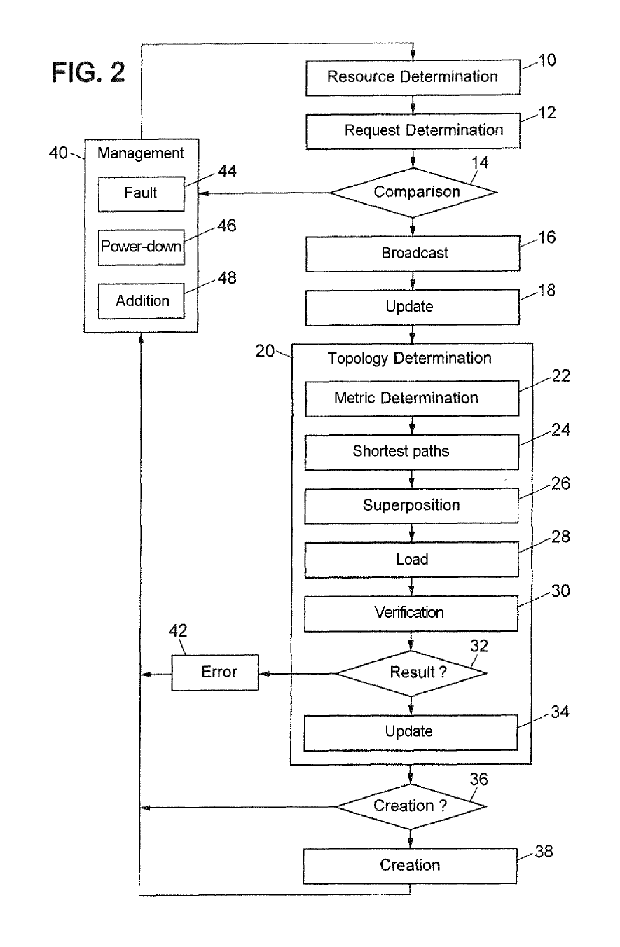

FIG. 2 is a flow diagram of the method for determination of topologies for virtual networks and for management of these topologies according to one embodiment of the invention;

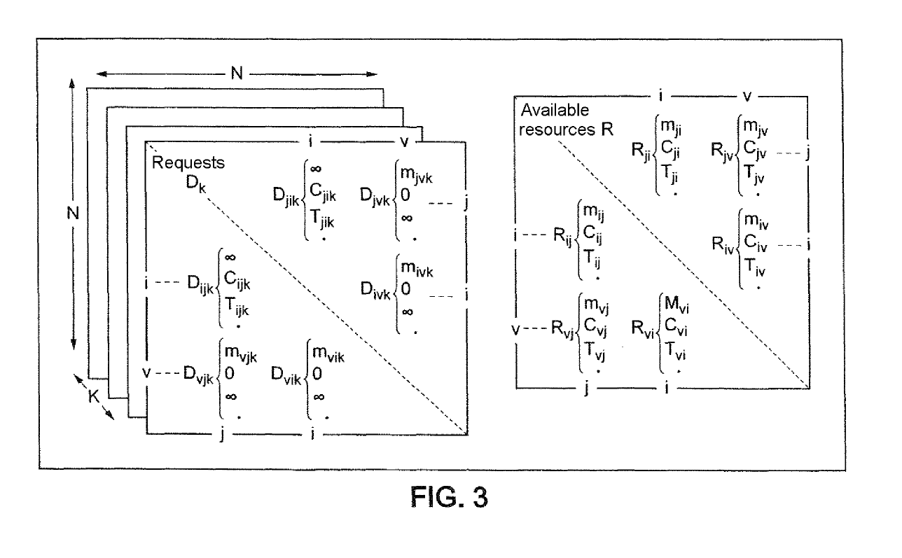

FIG. 3 shows matrices used in one embodiment of the method of the invention.

A method according to one embodiment of the invention will now be described with reference to FIGS. 1 to 3 in a configuration comprising K virtual networks on N network nodes. This configuration, shown with reference to FIG. 1, comprises N real nodes, or nodes of physical networks, denoted 6₁ to 6_{N}, connected by the physical network 2 and supporting the K virtual networks 4₁ to 4_{K}. In the N real nodes are found virtual routers denoted 8ᵢⱼ. Generally speaking, network graph refers to the description of the physical network 2 and topology of the structure of each of the virtual networks 4.

The method for determination of topology of virtual networks enables determination of the topology and the subsequent implementation of the virtual networks.

This method commences with an acquisition 10, by each node of the physical network 6, of data defining the physical configuration of the network graph and of that of the physical node.

This may be carried out by means of predetermined configuration files and/or by analysis of the local and remote resources based on information received from the other nodes of the physical network.

The transmission of this information is implemented within the physical network 2 by a routing protocol of the IGP (Interior Gateway Protocol) type. The data received come from the broadcast from each physical node 6, of the elements relating to the description of the physical configuration and notably:
the active adjacencies between the nodes of the physical network;
the metrics and the IP prefixes associated with these adjacencies;
the resources available over the links (bandwidth, etc.);
the transit time over the physical links connecting the neighboring machines;
the processor processing capacities and the memory capacity of the physical node.

Thus, each node of the physical network has descriptive information on its own physical characteristics, on the physical characteristics of the other nodes of the network 2 and on the physical characteristics of the links of the network graph 2.

Conventionally, for example by making reference to the routing protocol known by the name IGP (Interior Gateway Protocol), use is made of matrices referred to as adjacency matrices which define the graph of the network 2 by means of metrics representing a “distance” between the nodes of the network.

In conventional physical networks, the metric is unique by adjacency. However, the situation is more complex in virtual networks. For this reason, for each node of each virtual network, a matrix taking into account the metrics determined based on different constraints should be defined, for example the transit time between the nodes of the virtual network, but also the constraints of the service, the constraints of the physical network such as the available bandwidth and the constraints of the physical machine.

For this purpose, an extended adjacency matrix is defined in order to take into account the physical capacities of the network, the physical machines and the constraints relating to the superposition of the networks. This extended adjacency matrix, or resources matrix, of dimensions N×N, is denoted R with reference to FIG. 3 and describes the physical resources available between the nodes of the physical network connected according to the topology of the network.

The resources matrix R is composed of elements Rᵢⱼ which are vectors describing the resources available between the nodes 6ᵢ and 6ⱼ expressed based on the criteria defined in order to describe the service requests of the virtual networks such as bandwidth, transit time, availability ratio, jitter factor, etc.

In the embodiment described, each vector Rᵢⱼ comprises an indication of the metric type, intended to take into account the connectivity between the nodes and hence to take into account the physical topology.

Thus, the elements of the matrix R are of the type Rᵢⱼ=(m, C, T, G, . . . )ᵢⱼ (metric, capacity of the link, transit time, etc.).

Furthermore, with each physical node 6 is associated a vector defining the material capacities of this node (processor, memory, etc.) This vector is represented, in the embodiment described, in the form Pₙ=(M,P, . . . )ₙ (Available memory, processor capacity, etc.), n ε [1,N].

The method also comprises a determination 12 of the service requests such as a minimum bandwidth, a maximum end-to-end transit time, a maximum jitter factor and of other parameters between the virtual routers for access to a virtual network for a given client.

In the case where the virtual network must have a predetermined topology, the requests comprise, aside from the description of the service requests, data associated with the topology of the virtual networks. This data determines the metrics attached to the links of the virtual network and describe the given topology.

It is equally possible to receive data that only partially describe the topology and only supply metrics on certain links.

A request for creation of a virtual network may be received from several sources. Notably, such a request can come from:
an administration platform, connected onto the physical network and which generates requests in a format defined for an exchange protocol;
the access points, potentially using an automatic process of connection to a virtual network;
any given node of the physical network using a physical level configuration interface.

In order to take into account these requests, another matrix should be defined allowing the received data to be organized.

Considering the network with N nodes and K virtual networks, the step 12 allows a requests matrix, of dimensions N×N×K, denoted D with reference to FIG. 3, to be determined. This matrix D is composed of K N×N matrices denoted Dₖ, which represent the service requests between the access points to the virtual networks.

Each request matrix D_{K} associated with the virtual network of rank k ε [1, K] has dimensions N×N and has an index k in the request matrix D: Dₖ={Dᵢⱼ}ₖ.

Each matrix Dₖ describes, on the one hand, the request for required resources between the access points to the virtual network and, on the other hand, metrics mᵢⱼ for the links assigned at the virtual level k between the physical nodes Nᵢ and Nⱼ.

In one embodiment, the metric mᵢⱼ comes from the calculation by a metric assignment algorithm based on the characteristics of the physical network and on the type of service requested.

In another variant, the metric is already predetermined, in particular, in the case of a predetermined topology or engineering request by a client.

Thus, at the end of the steps 10 and 12, the method disposes of the contents, of the vectors Pₙ for the material capacities of each physical node 6, of the resources matrix R for the physical network and of the requests matrix D. These matrices R and D are shown in FIG. 3.

In this figure, the elements of matrix Rᵢⱼ, Rᵥⱼ, Rᵢᵥ and their symetrics with respect to the diagonal define the metrics of the graph of the network 2 at the physical level and the available capacities of the links between the nodes 6ᵢ, 6ⱼ, and 6ᵥ. The links not connected are characterized by an infinite metric m=∞ and zero capacities.

At the virtual level k, Dᵢⱼₖ and Dⱼᵢₖ express the request for the capacities (Cᵢⱼₖ Tⱼᵢₖ, etc.) between the virtual routers 8ᵢₖ and 8ⱼₖ which are access points to the virtual network 4ₖ. The metric, for example for Dᵢⱼₖ, is infinite, which means that, despite the existence of a physical link between these nodes, the virtual topology of rank k has not assigned any links between these virtual routers.

Dᵥⱼₖ and Dⱼᵥₖ express the metrics of the paths of the network of rank k between the nodes 8ᵥ and 8ⱼ. The virtual node 8ᵥ is not a point of access to the virtual network. The capacities are set to the limiting values: for example for Dᵥᵢₖ, the capacity in bandwidth is at zero and the transit time over the links is infinite, indicating that there has been no request for resources between these two points. The same is true for Dᵥᵢₖ and Dᵢᵥₖ.

The first time that the method is implemented, these steps 10 and 12 correspond to the initialization of the graph and topology data for the management of the virtual networks. Later on, these steps are the result of modifications of the physical configuration (fault, addition of a node, etc.) or of modifications of the service requests.

The method then comprises a test 14 for evaluating whether the data relating to the resources or to the requests have changed. In the case of an initialization, since the matrices and vectors are initially virgin, the presence of data constitutes a change.

During normal operation, in the absence of a change, the method goes to a management step 40 described later on. Indeed, in the case where neither the resources nor the requests have been modified, the current data defining the topology of the virtual networks, and on which the management is founded, does not need to be modified.

In the case where the node of the physical network 6 detects a modification in one of the matrices R or D or in the vector P, the method continues with broadcast 16 of the modified information.

This broadcast 16 is implemented within the physical network 2 by a routing protocol of the IGP type. The data are broadcast by each physical node 6ᵢ to all the other physical nodes 6 of the network.

The data transmitted relate notably to the descriptive data for the physical configuration and notably:
the active adjacencies between the nodes of the physical network;
the metrics and the IP prefixes associated with these adjacencies;
the available resources (bandwidth, maximum jitter, etc.);
the available resources (data rate, jitter, etc.);
the transit time over the physical links connecting the neighboring machines;
the processing capacities of the processor and the size of the memory of the physical node.

In parallel, the data associated with the topology of the virtual networks are also transmitted during the broadcast 16. These data are defined in the following two ways.

When a virtual network is automatically created, the request for resources only relates to the access nodes to the virtual network. This request is expressed in the format defined for the vector Dᵢⱼₖ. It is characterized by the data of a metric (of coordinate m) at 0.

In the case where the virtual network has a given topology, the request for creation of a virtual network is described in the same format Dᵢⱼ and expresses the requests for resources in the same way. The request furthermore comprises a description of the topology of the virtual network. This topology is expressed by the “metric” coordinate of the vectors which describe the structure of the network in question.

It is of course possible to compose these two modes by fixing metrics only on certain links and by determining the other metrics automatically.

The broadcast 16 of the data by a node of the physical network corresponds, from the point of view of the nodes of the physical network that receive these data, to a step of determination of the resources or requests in such a manner that each node has the same matrices and vectors defining the resources and the requests.

After the data broadcast, the method comprises the updating 18 of the matrices in order to incorporate the modified data. Notably, in certain embodiments, the transmitted data must be reformatted prior to being incorporated into the matrices. In other embodiments, the data are transmitted in a format corresponding to the format of the matrices.

The broadcast step 16 and updating step 18 may be carried out simultaneously or in different order than the order described.

The method then comprises a step 20 of determination of the topology of the virtual networks. This step is carried out by each physical node and for each virtual network. According to the embodiments, all of the topologies are determined simultaneously by carrying out the step 20 in parallel for each virtual network or else sequentially according to an arbitrary order or an order fixed by operating constraints.

Each node of the physical network uses the data exchanged previously for the calculation to determine the topologies of the virtual networks.

This determination 20 starts with the search for a topology and with a set of resource reservations compatible with both the resources available on the physical level and with the service requests.

Several determination methods may be envisioned that are more or less complex, combining operational search elements and heuristic methods specific to the architecture of the support networks. These calculations depend not only on service guarantee constraints or on QOS but also on statistical or commercial aspects and relate to the service package.

The main features of an exemplary embodiment of the calculation operations for determination of the topology are described hereinafter. In the formulas presented hereinbelow, an operator “.” (dot) is defined. Its use in the form V.X describes the X component of a vector V.

The first calculation 22 consists in determining, for each link of the physical network 2, the metric associated with it in the virtual plan to be created based on the matrix R of the resources available over the links of the physical network and on the vector Pₙ of the resources available on the nodes of the physical network. If this metric is already defined in the matrix Dₖ, it is the predefined value that must be taken into account.

For this purpose, a transfer function φₖ of R→IR+ is associated with each virtual network. The result of the application of this function to the graph data is a metric expressed according to the protocol of the IGP type for each link of the physical network. The transfer function is furthermore adapted to the nature of the service request and calculates the metric to be associated with the virtual links based on the characteristics of the physical links, and where relevant on any statistical or commercial rules. This calculation will enable the shortest paths to be determined in the physical network with regard to the metric of the virtual network that must be created.

A simple realization of this function could be based for example on the transit time or the bandwidth of the physical links. The use of these metrics allows the choice of a virtual network topology which corresponds to the required criteria. The metrics will be supplied by default to the virtual routers when they are created.

In the example described, the calculation for determination of the topology of a network is then carried out according to the following algorithm:
calculation 24 of a set of shortest paths relating to the metrics calculated for the virtual network between each pair (Nᵤ, Nᵥ) of access points to the virtual network; in the embodiment described, use is made of the algorithm known as the “n shortest paths” algorithm which allows the n shortest paths between two points to be determined;
union 26 of these shortest paths in such a manner as to create a topology for the virtual network that is sufficiently meshed and resilient; union is understood to mean a union in the mathematical sense or superposition;
determination 28 of the load of the links based on the additives requests for resources such as the bandwidth for example.

It will be noted that different metrics may be used for the various virtual networks such that the shortest pathways can vary from one virtual network to another.

At this stage of the calculation, a new matrix is defined for the processing and the storage of the resources allocated to the virtual network of rank k created: the matrix Rₖ of vectors Rᵢⱼₖ whose structure is identical to that of the vectors Rᵢⱼ of the matrix R. The vector Rᵢⱼₖ describes the resources needed and allocated for the virtual network of rank k over the links 4ₖ of the physical network.

In addition, for each node 8ₙₖ of the topology of a virtual network of rank k, a vector Pₙₖ=(Mi, Pi, . . . )ₖ is defined whose coordinates are the processing resource parameters needed and allocated on the node.

The calculation of the load of the links can be carried out in the manner described hereinbelow.

Denoting Sₖ as the set of the service access points to the virtual network 4ₖ, the sets Eᵤᵥ of paths of the graph of the physical network 2, calculated and retained during the preceding step, which connect the pairs of nodes (Nᵤ, Nᵥ) ε Sₖ×Sₖ are considered. A path eᵤᵥⁿ ε Eᵤᵥ, n ε [1, Card(Eᵤᵥ)] is expressed in the form of a finite ordered series of physical nodes eᵤᵥ=(Nᵢ)ᵤᵥ. Denoting C_{i,i}+1 as the capacity to be reserved for the pair (Nᵤ,Nᵥ) over the links (Nᵢ,Nᵢ₊₁), then C_{i,i}+1=Dᵤᵥₖ.C.

This means that whatever the links belonging to the paths that connect the access nodes Nᵤ and Nᵥ, the capacity requested at the rank k between these nodes is reserved over this link, even if several paths go via this link. This is expressed according to the following equation:

∀eεEᵤᵥ, ∀Rᵢⱼεe,Rᵢⱼₖ.C=Dᵤᵥₖ.C

In one variant, the set of the pairs (u,v) of Sₖ×Sₖ is defined according to the following equation:

γᵢⱼₖ={(u, v)εSₖ×S_{k}/∃eεE}ᵤᵥ/Rᵢⱼεe.

As a consequence, at least one path of Pᵤᵥ goes via the link Rᵢⱼ. The capacity Cᵢⱼₖ to be reserved from the resources over this link is obtained by summing the requests for capacity between pairs of access nodes (Nᵤ,Nᵥ).

Considering the virtual graph of rank k:

$${G}_{k} = {⋃}_{u , v ∈ {S}_{k}} {E}_{u , v} ,$$

then:

$$∀ {R}_{ijk} ∈ {G}_{k} , {R}_{ijk} \cdot C = {C}_{ijk} = {\sum }_{( u , v ) ∈ {γ}_{ijk}} {D}_{uvk} \cdot C .$$

Following the calculation of the load of the links, the process for determination of the topology comprises a verification 30 of the availability of the resources. This verification is carried out for each virtual network at several levels:
at the level of the nodes of the virtual network, by verifying that for any node 8ₙ of the network and for any criterion X defining the processing capacity on the node the difference is positive or zero:

$${P}_{n} \cdot X - {\sum }_{k} {R}_{nk} \cdot X \geq 0 ;$$

at the level of the links, by verifying that for any pair 8ᵢ, 8ⱼ of nodes of the virtual network connected by an adjacency, the residual capacity X on the physical link of the resources, the consumption of which is added up as virtual networks are added (the bandwidth for example), is positive or zero:

$${R}_{ij} \cdot X - {\sum }_{k} {R}_{ijk} \cdot X \geq 0 ;$$

at the level of the path, assuming that the transit time over a link that is not overloaded does not depend on its load, the algorithm verifies that the transit time over any path e connecting two access nodes 8ᵤ and 8ᵥ of the virtual network k meets the end-to-end transit time request:

$${\sum }_{{R}_{ijk} ∈ e} {R}_{ijk} \cdot T \leq {D}_{uvk} \cdot T ;$$

at the general level, by verifying that for all the specified quantified criteria for the path, such as, for example, the maximum permitted jitter, the physical network offers the requested resource.

It goes without saying that other methods or heuristic approaches may be employed for the determination of the topologies of the virtual networks.

Once the calculation is finished, the method executes a test 32 on the result of the verification. If all the resources requested are available, the topology of the corresponding network is validated and the test is followed by an updating 34 of the matrices defining the virtual networks and notably:
of the resources allocated to the various physical links: in the vectors Rᵢⱼₖ of the resource matrix Rₖ;
of the processor resources allocated for each node in the vector Pₙₖ;
of the metrics in the matrices Dₖ and Rₖ.

As previously indicated, the step 20 is implemented for each virtual network. Thus, at the end of these steps, a topology is determined for each virtual network.

The method then comprises a test 36 for determining whether one or more virtual routers belonging to these new topologies of the virtual networks need to be created on the physical node. In the case where this test is positive, the method creates these virtual routers during a step 38.

Each node of the physical network via which one path of the determined new topology passes for the virtual network of rank k must comprise a virtual router 8ₖ.

The creation 38 commences by the creation of a virtual machine and of its operating system, such as for example Xen and Linux, or of a process of undertaking the supports for management of the virtual processing operations referred to as “OEM supports”.

The virtual router itself will be created in this environment. The installation and start-up comprises a set of operations which depend on the way in which the corresponding virtual network is administered. In one embodiment, this involves an automatic creation based on a given protocol. As a variant, there is a creation administered by the client on the basis of the virtual machine supplied to him.

In any case, the process of determining the topology of the virtual network guarantees that the requested resources are available over the paths determined by the creation algorithm.

Advantageously, once created, each virtual router activates its own routing protocol which broadcasts data to the other routers of the virtual network 4 on which it is located and is naturally incorporated into the topology of the virtual network. The reason for this is that, on each node of the physical network, each virtual router has calculated the same calculations with the same data and hence knows the location of the other routers. As a result, the virtual network does not require any particular implementation signaling on the part of the physical network.

Accordingly, the determination of the topology is carried out automatically and autonomously by each node of the physical network without the need for transmission of the parameters descriptive of the topologies of the virtual networks.

The method then comprises a step 40 of management of the virtual networks. The management 40 is implemented following the determination of the topology of the virtual networks.

In particular, in the case where the test 14 indicates that nothing has changed in the topology, the method goes directly to this step. Similarly, if the test 32 indicates an error, the method optionally comprises the emission 42 of an error message then the management step 40. The method also goes directly to the management step 40 if the test 36 indicates that a new router does not need to be created.

Generally speaking, the management step 40 manages the modifications of the physical network or of the virtual networks, or events, before iterating the sequence of the steps 10 to 38 of determination of the topologies of the virtual networks. The descriptive information for the new configuration is determined by a router or an administration platform and transmitted to all the nodes of the physical network using the physical level exchange protocol similar to that of a conventional IGP (ISIS, OSPF for example). The other routers receive the new configuration and execute the determination of the topology on the basis of this configuration. These changes may for example relate to:
modification of the physical support;
a fault on a link or a physical node;
shutdown of a machine for maintenance;
addition of an access point;

These various changes will result in specific commands broadcast via the exchange protocol. They are taken into account by the management process and lead to the updating of the matrices R, D, of the vector P and the recalculation, by each node of the configuration, of the virtual networks.

In one particular case, the management 40 also comprises automatic recovery from a fault 44.

This recovery in the event of a fault of a link or of a physical node comprises two aspects made independent.

The recovery first of all comprises the transmission of fault information at the physical level and at the level of the virtual networks.

During the step 44, each IGP of an affected virtual network ensures convergence of the topology of the corresponding virtual network by relying on its resilience in order to provide the transport of the data despite the fault. This is totally transparent for the physical network that carries out its own convergence at the physical level.

Subsequently, resource and request parameters are updated and the method is reiterated on each physical node and for each of the virtual networks concerned by the fault. The method continues with the new resource and request parameters incorporating the consequences of the fault.

By iterating the method described previously starting from the step 10, the modified matrix R is automatically deduced from the new topology determined by the physical level IGP by hiding from it the links concerned by the fault. Similarly, the matrices Dₖ are determined starting from the existing matrices Dₖ by hiding from them these same links. Furthermore, the data attached to any potentially culpable nodes are hidden from the vectors P and Pₙ. Lastly, the virtual topologies are recalculated on these new data by conserving the metrics determined in the matrices Dₖ on the unaffected virtual links.

The management of a fault therefore boils down to the creation of a virtual network whose topology is partially predetermined. The links that are not usable by the new topology will not be taken into account.

In this embodiment, taking into account the metrics and hence the links, already determined in the matrix Dₖ, avoids a complete regeneration of the virtual networks impacted by the fault since the management process recovers the links which maintain the connectivity of the networks. The calculation of the new networks is only necessary as a complement for the deteriorated networks in order to re-establish the resilience and the requested capacities.

In this process, the reserved resources which are attached to the links in the matrices Rₖ and Dₖ and to the resource vectors Pₙ are conserved while waiting for the fault to be repaired, in other words for the machine to restart or for the links to be re-established. The hidden elements will then be freed up and reintegrated into the recalculated topology.

In another particular case, the management step 40 also comprises a power-down for maintenance 46 of a node of the physical network.

The power-down process is similar to the process of recovery from a link or physical node fault. However, in contrast to the fault, the power-down is predictable.

In the embodiment described, the power-down 46 comprises a declaration of an inoperable status for the node of the physical network prior to the latter being powered down. During a transition phase, the virtual routers affected continue to switch the packets that they receive. Simultaneously, the protocol of the IGP type broadcasts the information causing a re-convergence of the physical network graph.

As regards the management of the virtual networks, once the physical machine has been declared as inactive, the management process is restarted with the new resource parameters. The method allows the new paths to be determined and triggers the creation of replacement virtual routers without the virtual networks being affected. The physical machine is then stopped. When the physical machine is stopped, the routing protocols of the virtual networks take into account the modification by converging onto a network which has conserved resources in accordance with the initial request.

In the case of a temporary interruption, as in the case of the fault, certain resources can remain reserved until it restarts.

In the case of a fault or stoppage for maintenance, the resources that have been assigned, together with the virtual routers that have been created in order to reestablish the characteristics of the network when it was stopped, must be restored.

In yet another particular case, the management step 40 comprises the addition 48 of one or more access points to a virtual network.

The method restarts directly at the acquisition step 10 with a new request for resources. The application of the method automatically leads to a new topology that takes into account these new access points.

Advantageously, in the processes described hereinbelow, the calculation or recalculation of a topology for a virtual network preferentially uses the links declared in the matrix Dₖ by their metrics. These links are predetermined for topologies imposed or already in operation by the calculation process. If a predetermined link is not suitable for the constraints established for a given path, the management process determines an alternative path. Once the calculation has finished, an installation option allows or does not allow the management software to remove the redundant links of the matrices Dₖ and Rₖ.

The method of the invention can be implemented by a physical node comprising processors, memories and conventional network management means including encoders, decoders, transmission units, IGP and others. Such a node also comprises specific means designed for the implementation of the method such as previously described.

Notably, such a node comprises a unit for determination of resource parameters defining a physical configuration of the physical network and a physical configuration specific to the physical router, a unit for determination of request parameters defining service requests relating to the virtual networks, together with a comparator between the parameters at a current point in time and the parameters at a preceding point in time, means for broadcasting new parameters to each of the routers of the physical network, means for updating resource and request parameters as a function of the modified parameters, a processor designed for the determination of topologies for the virtual networks by means of the updated parameters.

Furthermore, such a node can comprise a unit for verifying the availability of the resources for a virtual network.

The invention can also be implemented by a computer program loaded into a memory and designed for the implementation of the steps of the method previously described when the program is executed by a processor.

1. A method for determination of topologies of virtual networks, physical nodes being connected by a physical network and being designed to support virtual nodes of said virtual networks, said method comprising the following steps implemented by one of the physical nodes:
determining resource parameters defining a physical configuration of the physical network and a physical configuration specific to the physical node; and
determining request parameters defining service requests
relating to the virtual networks;
the method further comprising, in the case of modification of at least one parameter belonging to the group comprising the resource parameters and the request parameters between a current point in time and a preceding point in time:
broadcasting at least the modified parameters within the physical network;
updating the resource and request parameters as a function of the modified parameters; and
determining topologies for the virtual networks via the updated parameters.

2. The method as claimed in claim 1, wherein said determination of resource parameters comprises at least one step selected from the group consisting of:
utilizing predetermined configuration information;
receiving information coming from other physical nodes; and
acquiring local and remote resources.

3. The method as claimed in claim 1, wherein said determination of request parameters comprises at least one step selected from the group consisting of:
utilizing predetermined configuration information;
receiving information coming from other physical nodes; and
utilizing constraints on quality of service.

4. The method as claimed in claim 1, wherein said step for determining topologies for the virtual networks comprises, for each virtual network, verifying an availability of the resources.

5. The method as claimed in claim 4, wherein said step for determining topologies for the virtual networks comprises, for each virtual network:
determining metrics for each virtual link between the nodes of the virtual network;
determining shortest paths between the nodes of the virtual network;
performing a mathematical union of the shortest pathways in order to create a topology for the virtual network; and
determining loads of the links between the nodes of the virtual network.

6. The method as claimed in claim 1, wherein the method further comprises, depending on the determined topologies of the virtual networks, of creating at least one virtual router on at least one physical node.

7. The method as claimed in claim 1, wherein said steps of updating of the parameters and of determining the topologies are repeated at each modification of the request or resource parameters.

8. The method as claimed in claim 1, wherein the method further comprises managing the virtual networks

9. The method as claimed in claim 8, wherein the management of the virtual networks comprises, in the case of a fault in a node of the physical network:
broadcasting information within the physical network;
converging a graph of the physical network and of the topologies of the virtual networks affected by the fault;
updating the resource and request parameters while conserving the parameters defining the links not affected by the fault; and
performing an iteration of the method for the determination of the topologies.

10. The method as claimed in claim 8, wherein the managing of the virtual networks comprises, in the case of power-down, for maintenance of a physical node:
broadcasting information within the physical network;
converging a graph of the physical network and of the topologies of the virtual networks affected by the fault;
updating the resource and request parameters; and
after the power-down of the physical node, performing an iteration of the method for the determination of the topologies of the virtual networks.

11. The method as claimed in claim 8, wherein the managing of the virtual networks comprises, in the case of addition of one or of several access points to a virtual network, updating the request parameters and performing an iteration of the method for the determination of the topologies of the virtual networks.

12. A non-transitory computer program product comprising code instructions for the implementation of the steps of a method as claimed in claim 1 when said program is executed by a computer processor.

13. A physical node belonging to a physical network and being designed to support virtual nodes of virtual networks comprising:
a unit for determination of resource parameters defining a physical configuration of the physical network and a physical configuration specific to the physical node;
a unit for determination of request parameters defining service requests relating to the virtual networks;
a comparator between the request and resource parameters at a current point in time and the parameters at a preceding point in time;
a broadcasting element for broadcasting resource and request parameters within the physical network;
an updating element for updating the resource and request parameters as a function of the modified parameters; and
a processor designed for the determination of topologies for the virtual networks by way of the updated parameters.

14. The node as claimed in claim 13, wherein the node also comprises a unit for verifying availability of the resources for a virtual network.

15. A physical telecommunications network comprising a plurality of physical nodes connected together and designed to support virtual nodes of virtual networks, wherein at least two of said physical nodes are nodes as claimed in claim 13.
